(19) United States
(12) Patent Application Publication
(10) Pub. No.: US 2025/0054196 A1
(43) Pub. Date: Feb. 13, 2025

(54) MODEL AND SIMULATION TOOL FOR DIGITAL IMAGERY AND TERRAIN DATA

(71) Applicant: The United States of America, as Represented by the Secretary of the Navy, Crane, IN (US)

(72) Inventor: James Michael Hornef, Bloomington, IN (US)

(73) Assignee: The United States of America, as represented by the Secretary of the Navy, Arlington, VA (US)

(21) Appl. No.: 18/797,221

(22) Filed: Aug. 7, 2024

Related U.S. Application Data
(60) Provisional application No. 63/531,237, filed on Aug. 7, 2023.

(51) Int. Cl. G06T 9/00; G06F 16/29; G06T 11/60; G06T 17/05; G06V 20/10

(52) U.S. Cl. CPC G06T 9/001; G06T 11/60; G06T 17/05; G06V 20/10; G06F 16/29

(57) ABSTRACT

Disclosed is a model and simulation (M&S) tool that allows users to manipulate the metadata of terrain and imagery files (geoTIFF files) to represent changes in the terrain or even add assets to them, such as buildings, geographic features (e.g., changed geography), or trees The disclosed M&S tool is able to add and/or remove features from the geoTIFF file by either directly manipulating the metadata of the file or by creating what is termed herein as a “shapefile” to overlay the changes on top of the file metadata. This manipulation enhances the fidelity of older geoTIFF datasets by selectively updating and/or adding content to the data and allows users to rapidly generate usable datasets within a physics based digital environment.

### CROSS-REFERENCE TO RELATED APPLICATIONS

The present application claims the benefit of U.S. Provisional Patent Application Ser. No. 63/531,237, filed Aug. 7, 2023, and entitled “MODEL AND SIMULATION TOOL FOR DIGITAL IMAGERY AND TERRAIN DATA,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 211226US02) is assigned to the United States Government and is available for licensing for commercial purposes. Licensing and technical inquiries may be directed to the Technology Transfer Office, Naval Surface Warfare Center Crane, email: Cran_T2@navy.mil.

### FIELD

The present disclosure generally relates to model and simulation (M&S) tool for digital imagery and terrain data, and more particularly to an M&S tool providing the ability to improve the accuracy of digital imagery and terrain data by providing a user the ability to manipulate, smooth, and/or update the digital imagery and terrain data.

### BACKGROUND

Mission level Model and Simulation (M&S) provides the capability to model and validate real time experiments without the need for expensive iterative testing. In order to gather the highest fidelity data, quality information about the environment is needed, including imagery and terrain and potential obstacles. Existing georeferencing information files (e.g., geoTIFF) typically have a set resolution and are often missing small scale objects like buildings and trees. Accordingly, there is a need for an M&S tool that improves the accuracy of terrain and imagery data.

### SUMMARY

The presently disclosed invention provides an M&S tool, such as software and/or hardware, that improves the accuracy of terrain and/or imagery data in existing data sets through metadata manipulation. The present M&S tool is configured to work with geoTIFF terrain/imagery files and uses Latitude, Longitude, and Altitude (LLA) points for object insertion. This tool leverages two insertion procedures that focus either on object insertion, such as buildings, or on terrain manipulation, such as tree growth.

In further aspects, the presently disclosed M&S tool allows users to manipulate the metadata of terrain and imagery files (e.g., geoTIFF files) to represent changes in the terrain or even add assets to them, such as buildings or trees The presently disclosed M&S tool is able to add and/or remove features from the geoTIFF file by either directly manipulating the metadata of the file or by creating what is termed herein as a “shapefile” to overlay the changes on top of the file metadata. This manipulation enhances the fidelity of older geoTIFF datasets by selectively updating and/or adding content to the data and allows users to rapidly generate usable datasets within a physics based digital environment.

According to further aspects, a method is disclosed for model and simulation (M&S) of digital imagery and terrain data. The disclosed method includes receiving terrain and/or imagery files including geographic metadata, extracting the geographic metadata of the received terrain and/or imagery files, and modifying the extracted geographic metadata to represent changes in the terrain or to add assets to the received terrain and/or imagery files.

In other aspects, another method is disclosed for modifying terrain imagery files. This method includes receiving a terrain imagery file having embedded georeferencing metadata, extracting the georeferencing metadata from the terrain imagery file, assigning latitude and longitude ranges to the terrain imagery file based on the extracted georeferencing metadata, selecting boundary latitude, longitude, and altitude (LLA) points within the assigned latitude and longitude ranges for alteration using at least one object file, computing one or more intersections to determine points on a map that are within the selected boundary LLA points, assigning at least one of new elevations or new features to the terrain imagery file based on the determined points on the map, and generating a new terrain imagery file including the assigned at least one of new elevations or new features.

In yet another aspect, a non-transitory computer-readable medium storing computer executable code is disclosed. The code, when executed by at least one processor, causes the at least one processor to retrieve at least one GeoTIFF file, extract geographic metadata contained within the at least one GeoTIFF file, modify the extracted geographic metadata to represent changes in the terrain or adding assets to the at least one GeoTIFF file, and rewrite the at least one GeoTIFF file with the modified extracted geographic data.

In still one further aspect, an apparatus for modifying terrain imagery files is disclosed. The apparatus includes at least one processor, and at least one memory in communication with the at least one processor containing computer readable instructions. The at least one processor running the computer readable instructions is configured to retrieve at least one GeoTIFF file, extract geographic metadata contained within the at least one GeoTIFF file, and modify the extracted geographic metadata to represent changes in the terrain or adding assets to the at least one GeoTIFF file, and rewrite the at least one GeoTIFF

The presently disclosed M&S tool advances the field of imagery and terrain by allowing users to manipulate the metadata of existing datasets. This not only affords users the ability to update datasets to more accurately represent their environment, but also allows users to perform and model hypothetical scenarios (“what if”) with the terrain in an accurate and rapid fashion.

### BRIEF DESCRIPTION OF THE DRAWINGS

The detailed description of the drawings particularly refers to the accompanying figures in which:

FIG. 1 illustrates an example of terrain and imagery data that may be manipulated using the presently disclosed M&S tool according to aspects of the present disclosure.

FIG. 2 illustrates an example of a flow/system diagram of the presently disclosed M&S tool according to aspects of the present disclosure.

FIG. 3 illustrates one example of formatting for object files used by the presently disclosed M&S tool according to aspects of the present disclosure.

FIG. 4 illustrates an exemplary created mesh grid that is used to display metadata within a geoTIFF file using the presently disclosed M&S tool according to aspects of the present disclosure.

FIG. 5 illustrates one example of a User Interface allowing a user to select object/text files that they would like to be processed using the presently disclosed M&S tool according to aspects of the present disclosure.

FIGS. 6A, 6B, and 6C illustrates resultant intersections that may be generated as a fact check of imported LLAs using the presently disclosed M&S tool according to aspects of the present disclosure.

FIG. 7 illustrates one example of displayed data that includes all the added objects added by the presently disclosed M&S tool according to aspects of the present disclosure.

FIG. 8 illustrates an example of a command window output that may occur for an entire duration a run time by the presently disclosed M&S tool according to aspects of the present disclosure.

FIG. 9 illustrates an example of the resulting data where one view shows an illustration of the transmission of an RF signal using unaltered geoTIFF data in contrast with another view showing illustration of a transmission of the RF signal using a geoTIFF created with the presently disclosed M&S tool according to some aspects of the present disclosure.

FIG. 10 illustrates a flow diagram of one exemplary method according to some aspects of the present disclosure.

FIG. 11 illustrates a flow diagram of another exemplary method according to some aspects of the present disclosure.

### DETAILED DESCRIPTION

The embodiments or examples of the present invention described herein are not intended to be exhaustive or to limit the disclosure or invention to the precise forms disclosed. Rather, the embodiments and examples are selected to enable one skilled in the art to practice the present invention.

As background, it is noted that terrain files provide a Modeling and Simulation (M&S) scenario with the real world elevation of an environment, including buildings and trees, while imagery files provide the M&S scenario a way to visualize the environment. Terrain files have significant impacts on variables such as field of view and access between assets within an M&S environment. These files are often stored as geoTIFFs, or as a raster image that stores aerial imagery along with geographic metadata that describes the location in space of the image.

The presently disclosed M&S tool addresses, at least in part, a problem where it is difficult get quality terrain and imagery datasets to use in simulations. The presently known art involves acquiring terrain data by downloading the data from open source databases, such as GRID or ArcGIS, or obtaining the data through commercial purchases/proprietary agreements. While these sources have a wide selection, often the higher resolution scans are locked behind a paywall or classified due to their content. While this is a problem within itself, another problem is that many of these open source datasets are out-of-date when it came to the height of the foliage and other obstructions. Many test ranges on Department of Defense (DoD) sites, as a real world example, are located in rural areas and the growth of the surround foliage creates vastly different free space scattering characteristics that cannot be represented in models with the available terrain data. Accordingly, one aspects of the present M&S tool is to provide the ability to change the terrain data to thereby enhance the fidelity of the simulations that utilize this data.

Additionally, while the higher fidelity terrain data is desired, the terrain data scans often come with “artifacts”, or inaccuracies in the scanned data. These artifacts can originate from dense foliage, surfaces of water, or even poor weather on the day of the scan. In this case of artifacts or inaccuracies in scanned data, the present M&S tool (termed herein also with the acronym “DITTO” that stands for “Digital Imagery and Terrain for Tactical Operations” as applied to certain use cases) also affords the ability to “smooth out” or correct these artifacts and/or inaccuracies, which is the opposite of the foliage or obstruction issues discussed above.

Accordingly, the presently disclosed M&S tool (e.g., software and/or hardware) allows a user to manipulate the geoTIFF metadata of existing geoTIFF files to represent variables such as tree growth or to remove artifacts from the data. This presently disclosed M&S tool further affords the ability to add structures like buildings and natural obstructions into the dataset through “shapefiles” to increase the resolution. Selective manipulation of existing datasets allows users to increase the fidelity of their simulations without needing the highest, and often more costly, resolution dataset.

Furthermore, the presently disclosed M&S tool allows for manipulation of the metadata within the geoTIFF file to not only represent desired changes, but also to correctly reference the source latitude and longitude (Lat/Lon) grid and resolution. The difficult part of this process is to accurate referencing the original geoTIFF grid/boundaries and manipulate the grid in such a way that new “artifacts” were not created in the data set.

In particular, an accurate representation of the reference grid in the digital environment may be performed by making surface distance calculations based on the Lat/Lon points provided and the resolution of the reference grid. In further aspects, however, these processes may also be accomplished by creating one or more look-up tables (LUTs) of the grid that can be manipulated before actually overwriting the file.

Additionally, in order to prevent the creation of artifacts in the dataset when manipulating the metadata (e.g., artifacts originated from a mismatch in Lat/Lon point resolution between the reference grid and the desired change), image processing techniques may be utilized. In particular, it is noted that even with the use of digital LUTs, there still may exist a problem of matching the resolution of the desired change to that of the original geoTIFF file. Accordingly, rather than force the user to alter the resolution of their asset, the presently disclosed M&S tool allows the use of image processing techniques to ensure there is a proper placement of the asset on the gird. In aspects, the overall process is that the presently disclosed M&S tool creates a two-dimensional (2D) plane of the reference grid and object to be inserted and uses geometric intersections to map the “closest” point of the object's desired position to the available positions on the reference grid.

In still other aspects, it is noted that representing boundary conditions of buildings/obstacles in lower resolution datasets can also present challenges in terms of processing speed. Accordingly, in certain aspects the presently disclosed M&S tool affords the capability to lay objects on top of the terrain files via shapefiles. In still further aspects, the presently disclosed M&S tool allows for rapid creation of these files to enhance its terrain/imagery manipulation capability. A benefit of this features is that shapefiles are normally reserved for more urban areas and a locked behind paywalls. The addition of this functionality enhances the capabilities of the presently disclosed M&S tool to more accurately represent the environment without the need to pull data from multiple sources or have a funding line.

The presently disclosed M&S tool advances the field of imagery and terrain by allowing users to manipulate the metadata of existing datasets. This not only allows users to update datasets to more accurately represent their environment, but also allows users to perform “what-if” scenarios with the terrain in an accurate and rapid fashion. This is extremely advantageous in the world of M&S because it allow users to provide more accurate insights to questions such as “How will the change in environment affect my radio frequency (RF) signal strength?” or “What would happen to the RF signal if an obstacle or building was placed there?”

As described above, the presently disclosed M&S tool affords the ability to alter geoTIFF files, allowing a user to perform operations such as adding buildings or changing elevation of existing terrain. As stated above, terrain files provide the digital environment with the real world elevation of the site in question, while imagery provides the environment with a way to visualize the map.

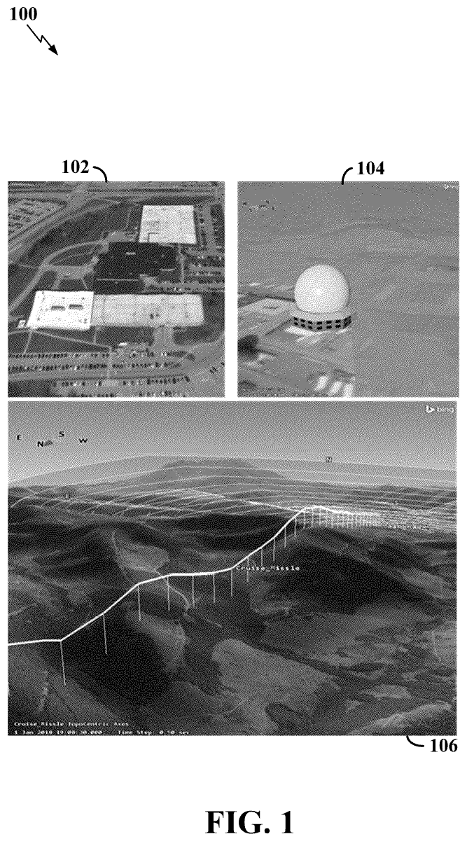

FIG. 1 illustrates an example 100 of terrain and imagery data that may be manipulated using the presently disclosed M&S tool. M&S suites will typically use these types of files to determine any field of view or access constraints between assets, including accesses such as direct line of sight and over the horizon communications using atmospheric models. With this in mind, the resolution and accuracy of the terrain data is vital for quality simulation results. In particular, FIG. 1 illustrates imagery data at 102. The data shown at 104 is an example of mask conditions using Systems Tool Kit (STK) objects. The data shown at 106 is an example of a terrain file of a drone maintaining fixed altitude over changing elevation.

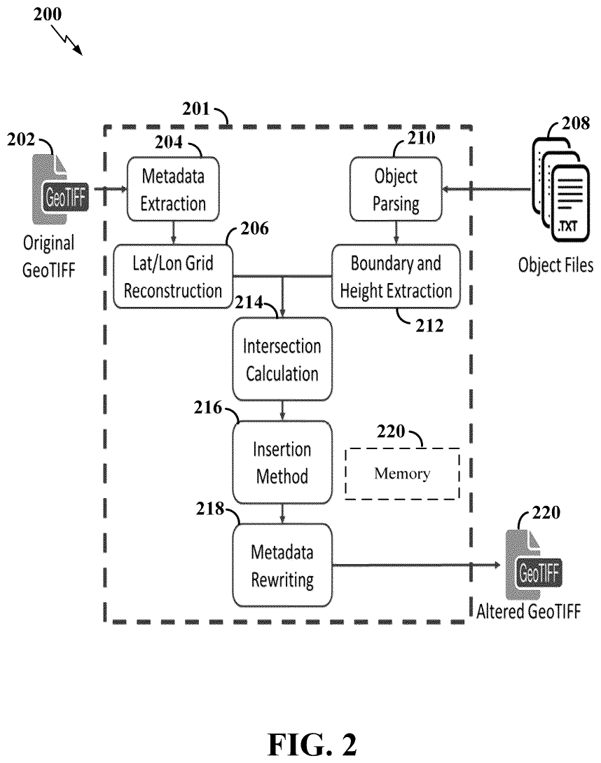

FIG. 2 illustrates an example of a flow/system diagram 200 of the presently disclosed M&S tool. The system 200 may include an apparatus 201, which may be embodied with at least one processor and memory device (not shown), and more particularly as a specific purpose processor or application specific integrated circuit (ASIC) in further examples. As illustrated, a user may select or, alternatively receive, a geoTIFF file 202 to alter, modify, or rewrite. The apparatus 201 is configured to then pull the metadata as shown at block 204 to, in turn, assign Lat/Lon ranges to the image and display it to a user (e.g., via a display, not shown). A Lat/Lon grid reconstruction (e.g., creation of an LLA mask using corner coordinates found in the geoTIFF information property or calculating the grid by using the total number of points versus the range) is then determined as shown at block 206.

Next, a user may select a region to alter through a text file (e.g., object files 208) with boundary LLA points (or alternatively download multiple text files to alter one or more regions). The files are parsed (object file parsing) as shown at 210 and the boundary and heights are extracted therefrom as shown at 212.

Using the data from blocks 206 and 212, the system 200 performs polygon intersection computations to determine which points on the map are within the boundary as shown at 214. Finally, new data values (e.g., regions, elevations, etc.) are assigned/inserted at shown at block 216. In some aspects, the processes in block 216 may employ either a top-down or bottom up method, and the metadata is rewritten as shown at block 218. The result is a new or altered geoTIFF file 220. In further aspects, for traceability, the region/elevation changes made are written to a separate file.

In further aspects, it is noted that system 200 takes in two primary inputs: (1) a geoTIFF terrain file (e.g., 202), and (2) any number of .txt files with the LLAs of the desired objects (e.g., 208). GeoTIFF files are aerial scans that have “metadata” of the Lat/Lon positions encoded into them. They also store information such as the grid resolution and scan boundaries, which are utilized within the system 200 for object alignment. The object files are descriptive LLA files that contain the name of the object to be inserted, the construction type for the insertion (will be explained in the insertion method section), the height of the object and the Lat/Lon points.

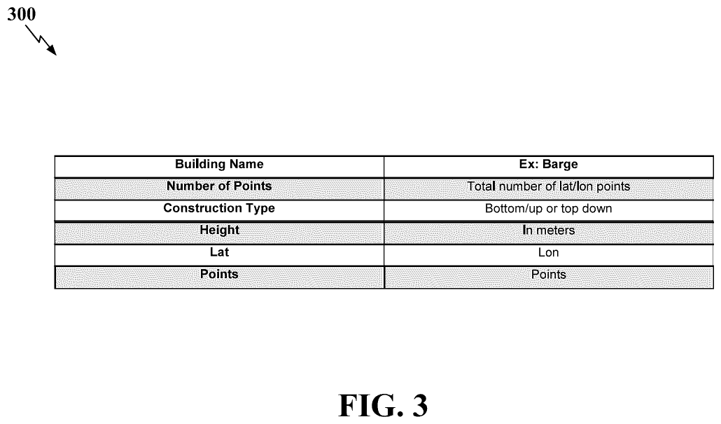

Concerning the object files (e.g., 208), in particular, these files may be .txt files configured to have a format as shown at 300 in FIG. 3, but not necessarily limited to just this formatting. As may be seen at 300, the files may include feature name, number of latitude and longitude points, image construction types (e.g., bottom up or top down), height and units of measurement of heights, and one or more latitude and longitude points.

Concerning the data handling illustrated in block 204 of FIG. 2, this process handles both elevation and imagery file types. These files types, while they have the same extension, contain different metadata. In particular, elevation files are used to create terrain data, while imagery data is used to create overlays. The processes in block 204 pull in the geoTIFF files into the MATLAB environment (as merely one example of language/coding that may be utilized) and stores the metadata information into a dynamic variable, known as the information property. The processes in block 204 may also include cleaning rough geoTIFF files by leveling out the extremely negative values (if present, they represent errors in the scan) and creates a blank copy of the metadata reference grid for the objects to be written to later. This may be a matrix of zeros that is the same size and resolution as the reference grid. In further aspects, the data input (e.g., block 204) may be further configured to accept mass data inputs, such as individual buildings in a city or dense point clouds and then parse three-dimensional (3D) file formats through its algorithm to the metadata, such as CAD, STL or point cloud files of buildings.

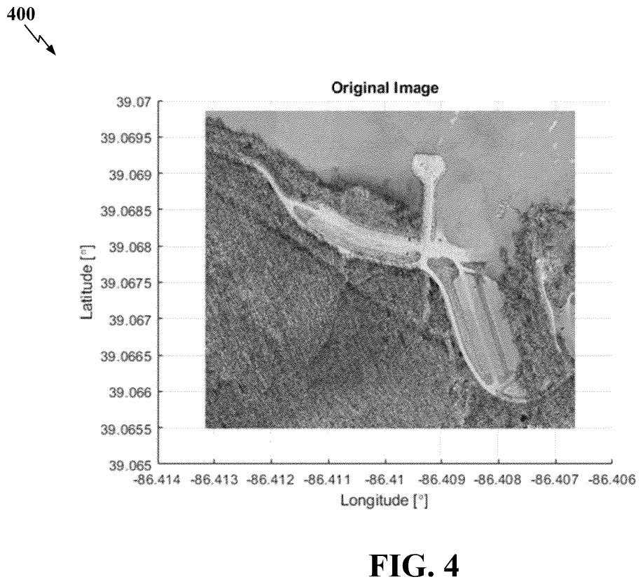

Concerning Lat/Lon mask creation as illustrated in block 206 of FIG. 2, one goal is to create a copy of the reference grid including its boundary points and the grid resolution. This mask is using the corner coordinates variable found in the geoTIFF information property, which may be pulled in the processes of block 204. For the grid resolution, some geoTIFFs do not have grid resolutions defined within the information property, so the grid resolutions are calculated by using the total number of points versus the range (assuming they are all equally spaced). This eliminates errors that arise from this property missing and, when available, is compared the grid resolution within the information property for accuracy. The corner coordinates and grid resolution are used to create a mesh grid of the Lat/Lon points, which is used as the ground truth reference grid for aligning the objects to be written on the geoTIFF metadata. As a fact check, a 2D image 400 of this created mesh grid is illustrated and used to display the metadata within the geoTIFF, as shown in FIG. 4. This may be included in the system 200 as a first error check that allows a user to confirm the validity of the reference grid and represents GeoTIFF metadata overlaid on the created Lat/Lon mask.

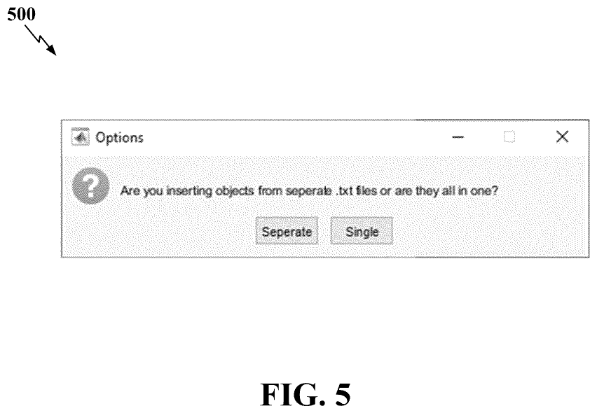

Concerning object importing as illustrated at 208, 210, and 212 in FIG. 2, the system 200 may be configured to collect the desired object files 208 to add to the geoTIFF. In one example, this importation may be accomplished using a “uigetfile” command, which creates a User Interface allowing the user to select files that they would like to be processed, an example of which is shown in FIG. 5. This import function allows a user to input the objects in two different ways; as a single file, or as a group of separate files. In some aspects, but not limited to such, all files must match the format shown in FIG. 3 to ensure proper parsing and recognition of the variables in the object files. In other aspects, an infinite number of latitude or longitude points may be handled. In further aspects, lines 1-4 must be in the file format shown in FIG. 3 for the buildings to be properly parsed and represented. Of further note, a readtable function, which may be used to input these objects into MATLAB, will automatically ignore the first four lines within a text file. When the readtable function is executed, it searches for a delimiter. In this instance of the present example, the input file is formatted for the function to recognize the Delimiter {′,′} and ignore Whitespace ′b\t\. Since the first four lines of the file do not follow a format that MATLAB recognizes T (i.e., data Table), the system 200 will import the first row that follows the delimiter constraint. In further aspects, when uploading multiple files, all files located in one folder (i.e. directory) may be optimal as selection of multiple files that are in different locations may not be available.

Concerning the geoTIFF file modification as illustrated in blocks 214, 216, and 218 in FIG. 2, these processes may be implemented within a recursive ‘for’ loop that performs the object insertion for each object one at a time, allowing for multiple objects to be placed in one file. The procedure begins with reading in the desired height of the object from the .txt object file. Next, the nearest neighbors between the object and the reference grid are found and stored in a temporary variable called and “object.” This prevents the original object from being written to “ghost” points and forces the object to the resolution of the original image for simplicity.

Next, the “objects” are converted into 2D filled polygons. These polygons are used to find the intersection points between the object and the reference grid using the ‘inpolygon’ function in MATLAB (as merely one exemplary language/code) resulting in a dataset that contains all the points within the boundary conditions set by the object. This converts the object from just boundary conditions to a solid shape that can be manipulated. The exact intersection Lat/Lon points are stored into ‘lat_intersect’ and ‘lon_intersect’, which will be used in the elevation alteration.

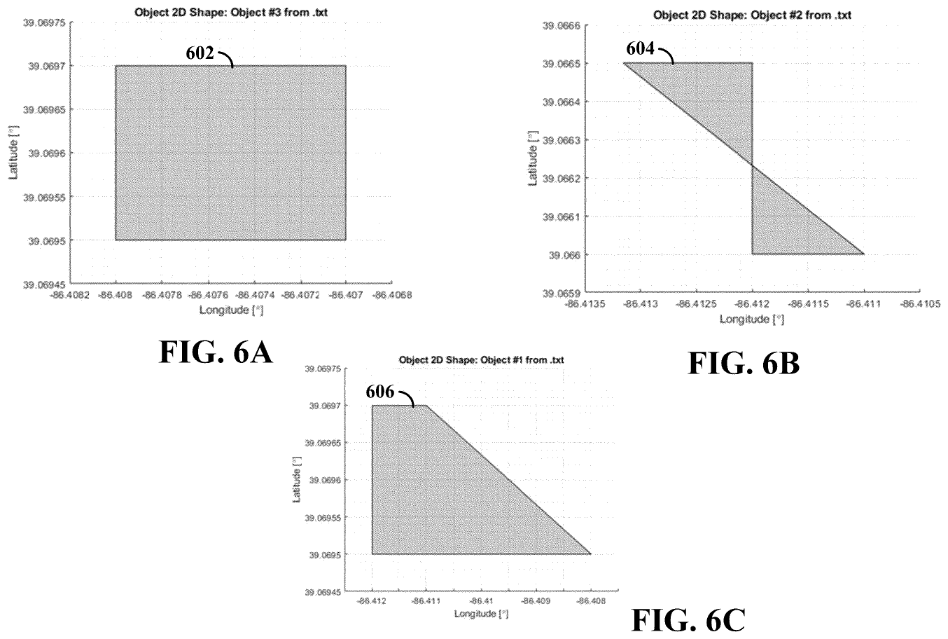

FIGS. 6A, 6B, and 6C illustrate resultant intersections 602, 604, 606 that may be generated by system 200 as a fact check of imported LLA. It is noted that, when using multiple object files, a separate 2D polygon will be made as a fact check for the user.

Next, the 2D object is converted to a 3D object through addition of Z-height or elevation to the data. This process has the ability to perform top-down and bottom-up insertion of objects. The top-down method is more suited for adding buildings and structures, as it will provide a fixed z-value. The bottom-up method is more suited for changing the elevation of the existing data, which would account for things like tree growth or pits. The user may define or select which operation they would like to perform within the object txt file. The user may also define one fixed z-value for the entire region or provide varying z-values in the .txt file in some aspects. Finally, at the end of the recursive ‘for’ loop in one example, the altered geoTIFF image (e.g., 220) may be displayed to a user via a display device. The displayed data may include all the added objects and is the result that will be written to the output file.

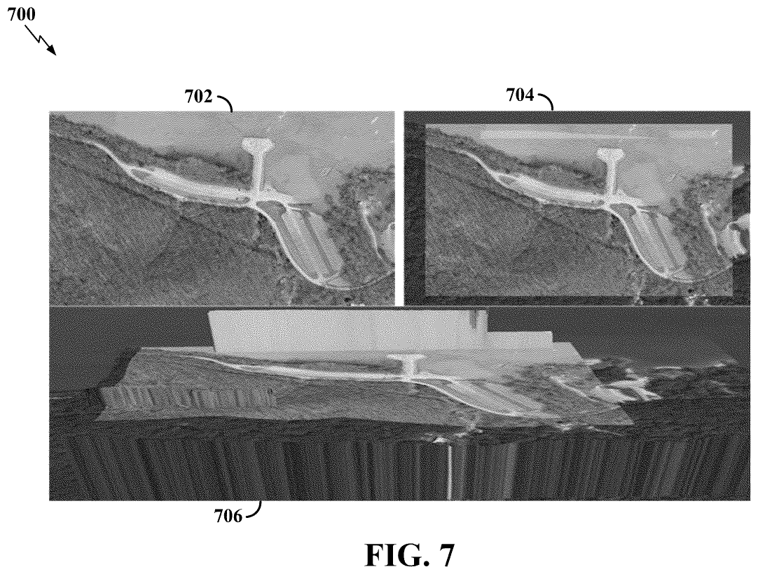

FIG. 7 illustrates one example of displayed data 700 that includes all the added objects added by the system 200. In FIG. 7, the original GeoTIFF image is shown at 702. The view at 704 shows the altered geoTIFF files with three different objects (shown in shaded areas) inserted at different heights. The view at 706 shows an isotropic view of the altered geoTIFF file, wherein the three different objects may be seen in relief at their respective different heights.

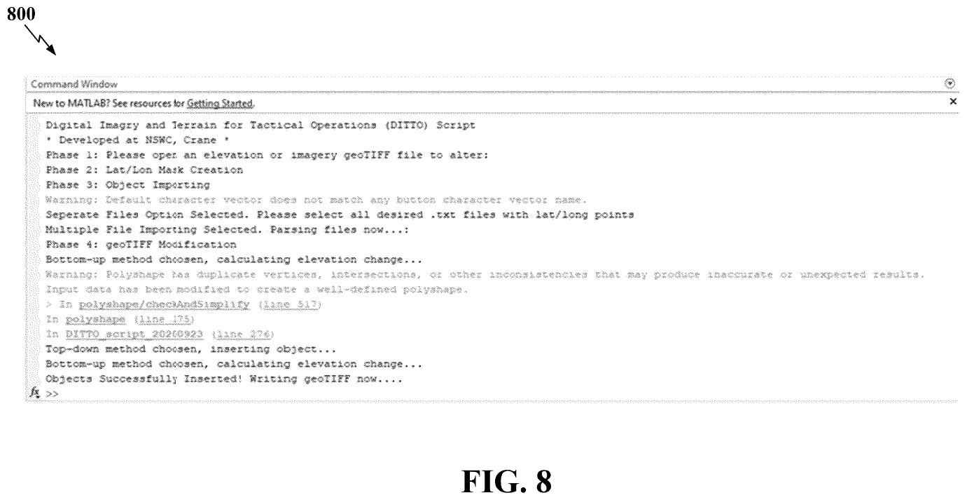

After the object insertion/elevation changes are finished, the new geoTIFF data is written as indicated at 220 in FIG. 2. In some aspects, output filenames may be generated by removing the original file extension and appending ‘_altered.tif’ to the name. The same procedure is used for generating an object file name. To write a geoTIFF file, the raster path, Lat/Lon limits and the start point for the rastering need to be defined (done with ‘R’). An example 800 of the command window output for the entire duration of a script run time is shown in FIG. 8.

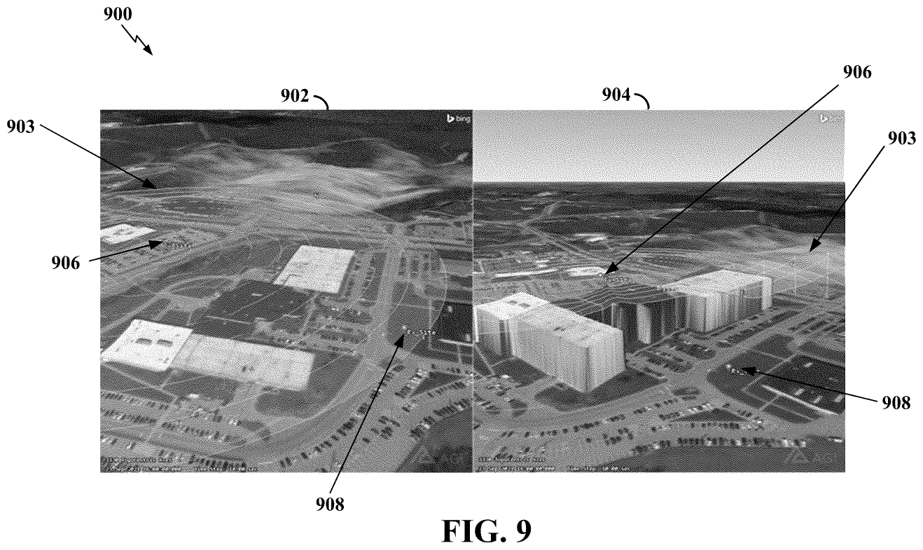

Further, the processes implemented in system 200, for example, allow a user to not only manipulate the existing geoTIFF data, but also to create usable terrain files for M&S suites. A practical example 900 of the resulting data is illustrated in FIG. 9, where view 902 shows transmission of an RF signal (shown by shaded region 903) using unaltered geoTIFF data, which is contrasted with view 904 showing transmission of an RF signal using a geoTIFF created with the system 200. The purpose of this simulation was to show the communication characteristics of a simple transmitter and receiver at a known location. The transmitter was placed a first location and the receiver was placed at another location shown in yellow text (906 and 908, respectively) in the figures. The publicly available terrain data for this selected location is at 10 meter resolution and, as shown in the image 902 of FIG. 9, causes major details like buildings to be misrepresented in the data. Without the model files for the building, they cannot be represented accurately in this model, creating a major inaccuracy in the results. Using the present system, the 2D Lat/Lon boundary conditions of the buildings were fed in as objects and were represented in the new geoTIFF file. When the simulation was run again, the buildings' elevations where accounted for in the communications calculation and providing more accurate results, as seen in the view 904.

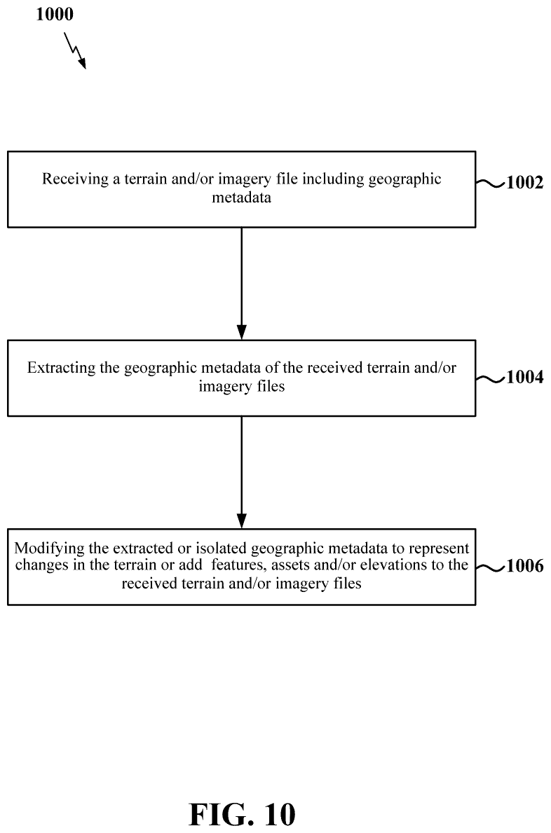

Turning to FIG. 10, this drawing illustrates a flow diagram of one exemplary method 1000 according to aspects of the present disclosure. As shown, method 1000 is a method for model and simulation (M&S) of digital imagery and terrain data. The method 1000 includes receiving terrain and/or imagery files including geographic metadata (e.g., geoTIFF files, but not limited to such) as shown in block 1002. In some aspects, the processes of block 1002 may include parts or all of processes 202, 204 and/or 206 in FIG. 2. Next, method 1000 includes extracting or isolating the geographic metadata of the received terrain and/or imagery files to obtain “extracted geographic metadata” as shown in block 1004. In some aspects, the processes of block 1004 may include parts or all of processes 204 and/or 206 in FIG. 2. Additionally, method 1000 includes manipulating or modifying the extracted or isolated geographic metadata to represent changes in the terrain or to add features, assets, or elevations to the received terrain and/or imagery files as illustrated in block 1006. It is noted that the processes of block 1006 may include one or more of blocks 208, 210, 212, 214, 216, and/or 218 in FIG. 2.

According to further aspects, method 1000 may include processes where modifying the extracted metadata includes rewriting the metadata of the received terrain and/or imagery files to create altered terrain and/or imagery files, such as is illustrated in blocks 218 and 220 of FIG. 2. In further aspects, it is noted that the added assets may include buildings, geographic features, or trees, as examples.

In yet further aspects, method 1000 may include receiving one or more object files such as is shown at 208 in FIG. 2. Moreover, the one or more object files may then be parsed to extract boundary or elevation characteristics contained within the one or more object files, such as shown in blocks 210 and 212 of FIG. 2 as one example. Moreover, the process of modifying the extracted geographic metadata to represent changes in the terrain or to add assets to the received terrain and/or imagery files illustrated by block 1006 may further include modifying the extracted geographic metadata based on the extracted boundary or elevation characteristic from the parsing and extracting of boundary or elevation characteristics performed earlier (e.g., see block 210 and 212). This process is illustrated in one example by blocks 214, 216, and/or block 218 of FIG. 2. Further, method 1000 may include the ability to modify the extracted geographic metadata to represent changes in the terrain or add assets to the received terrain and/or imagery files at the affirmative selection of the user (i.e., selectable by the user, rather than merely parsing object files input or to further be able to affirmatively modify the parsed object file data).

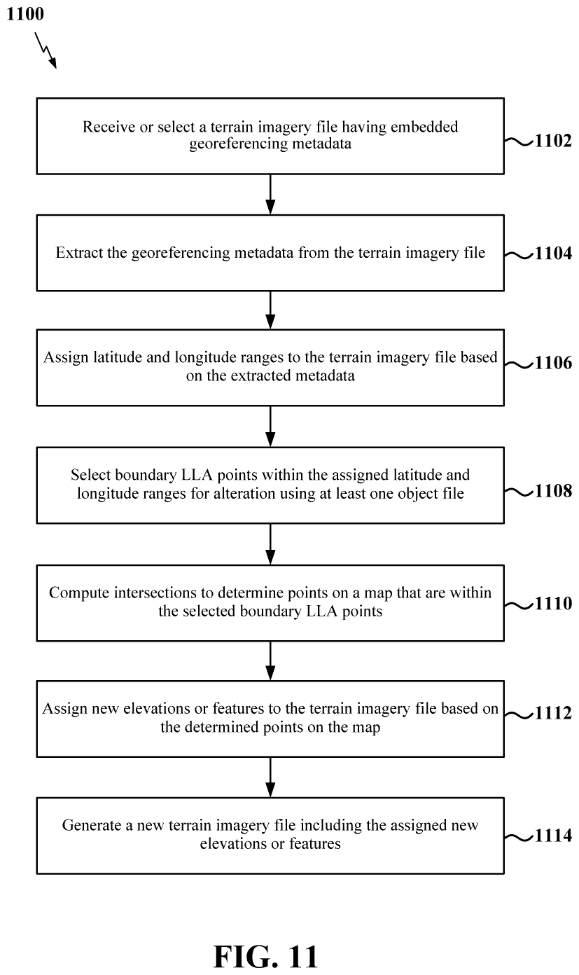

FIG. 11 illustrates a flow diagram of another exemplary method 1100 that may be implemented according to aspects of the present disclosure. In particular aspects, method 1100 affords users to be able to modify terrain imagery files (e.g., geoTIFF files) to perform operations such as adding buildings or changing elevations of existing terrain. First, block 1102 shown in FIG. 11 illustrates receiving (or a user selecting) a terrain imagery file with embedded georeferencing metadata, where the metadata describes the location in space of the image, such as with geoTIFF files as one example, but not necessarily limited to such. An illustrative example is shown at 202 in FIG. 2. Next, method 1100 includes extracting the metadata as shown in block 1104 and then assigning latitude and longitude ranges to the terrain imagery file based on the extracted metadata as shown in block 1106. Examples of these processes are illustrated by blocks 204 and 206 in FIG. 2. In some aspects, the processes of block 1106 may further include displaying the latitude and longitude ranges to a user such as via a display device.

Next, method 1100 includes selecting boundary latitude, longitude, and altitude (LLA) points within the assigned latitude and longitude ranges for alteration using at least one object or text file (e.g., .txt file) as shown at block 1108. In some aspects, a user may be enabled to be able to select a region to alter through the one or more text files with boundary LLA points (i.e., lat/lon boundaries and height extraction). An example of the processes performed in block 1108 include blocks 208, 210, and/or 212 in FIG. 2.

Method 1100 further includes computing intersections to determine points on a map that are within the selected boundary LLA points as shown in block 1110. In one example, the processes of block 1110 may include performing polygon intersection computations to determine which points on the map are within the boundary. In an example, the processes of block 1110 may be embodied by block 214 as shown in FIG. 2.

Next, method 1100 includes inserting or assigning new elevations or features as shown in block 1112 . . . . In an example, the processes of block 1112 may be embodied by block 216 as shown in FIG. 2. Finally, method 1100 includes rewriting or generating a new terrain imagery file including the assigned new elevations or features as illustrated by block 1114. In an example, the processes of block 114 may be embodied by blocks 218 (and 220 final output) as shown in FIG. 2.

In still other aspects, method 1100 may include that the new features include buildings, geographic features, or trees. Further, the terrain imagery file may consist of a geoTIFF file in one example. Additionally, the method 1100 may include receiving the one or more object files, and parsing the one or more object files for assigning the latitude and longitude ranges to the terrain imagery file.

In still further aspects, method 1100 may include generating a new terrain imagery file including the assigned at least one of new elevations or new features is selectable by a user. Additionally, method 1100 may include that the computing of the one or more intersections includes determining intersection points between an object obtained from the at least one object file and a reference grid (e.g., a map reference grid).

In further aspects, it is noted that the methods of FIGS. 10 and 11 may be performed for both elevation and imagery file types, where elevation files are used to create terrain data, while imagery data is used to create overlays.

The following code shown in TABLE 1 below illustrates merely one example of computer code, but not limited to such, that may be implemented with MATLAB for effectuating the systems and methods for the M&S tool described herein.

```
TABLE 1
  This script is for altering geoTIFF files, allowing user to perform
  operations such as adding buildings or changing elevation of existing
  terrain. First, user selects a geoTIFF file to alter. The script then pulls
  the metadata to assign the lat/lon ranges to the image and displays it to
  the screen. Next, the user selects a region to alter through a text file
  with boundary LLA points. Using this data, the script performs polygon
  intersection computations to determine which points on the map are within
  the boundary. Finally, the new elevations are assigned and a new geoTIFF
  file is generated. For traceability, the region/elevation changes made are
  written to a separate file.
  %}
    %%
    %%%%%%%%%%%%%%%%%%%%%%%%%%%%%%%%%%%%%%%%%%%%%%%%%%%%%%%%%%%%%%%%%%%%%%%%
    %--------------------------Key Variables---------------------------------
    --
    %{
        Input Variables
        1) orig_geoTIFF: GeoTIFF file (either elevation or imagery data)
    [.tif]
        2) Points: Text file containing LLA points of objects [.txt]
        Output Variables
        1) new_geoTIFF: New geoTIFF file with rewritten metadata [.tif]
    %}
    %%
    %%%%%%%%%%%%%%%%%%%%%%%%%%%%%%%%%%%%%%%%%%%%%%%%%%%%%%%%%%%%%%%%%%%%%%%%
    %----------------------Phase 1: Data Handling----------------------------
    --
    %{
        *This version of the script works for both elevation and imagery file
        types. Please be aware of which type is being use, as elevation files
        are used to create terrain data while imagery data is used to create
        overlays.
        Variables:
        inputPath: points to where the raw geoTIFF file directory is
        datapath: points to where the LLA file directory is
        outputPath: points to where the new geoTIFF data will be written
        filename: stores user input of the raw geoTIFF file
        name: combines the input path and file name for data reading
        orig_geoTIFF: creates an array by reading geographic or projected
        raster data from a geoTIFF file
        R: contains the geodetic reference information within the metadata,
        which will allow the script to pull parameters such as the lat/lon
        bounds and grid resolution
        info:creates a reference for all geoTIFF information to be called
    later
        new_geoTIFF: creates a copy of the original image for alterations
        z: Creates a blank matrix to write the object to
    %}
    clc; clear; close all;
    % Data paths for data sorting (***changed per user***)
    inputPath = ′Raw Data\′;
    datapath = ′LLA Data\′;
    outputPath = ′Altered Data\′;
    % Gives access to TIFF file
    disp(′Digital Imagry and Terrain for Tactical Operations (DITTO)
    Script′);
    disp(′* Developed at NSWC, Crane *′);
    disp(′Phase 1: Please open an elevation or imagery geoTIFF file to
    alter:′);
    filename = uigetfile({′*.*′});
    name = strcat(inputPath,filename);
    [orig_geoTIFF,R] = readgeoraster(name); % creates an array by reading
    geographic or projected raster data from a file
    info = geotiffinfo(name); % creates a reference for all geoTIFF
    information to be called later
    new_geoTIFF = orig_geoTIFF; %Creates a copy of the image for alterations
    new_geoTIFF(new_geoTIFF<−40) = −40; % This cuts the tiff to a reasonable
    negative limit, if needed
    z = int16(zeros(size(new_geoTIFF,1),size(new_geoTIFF,2))); %Creates a
    blank matrix to write the object to
    %%
    %%%%%%%%%%%%%%%%%%%%%%%%%%%%%%%%%%%%%%%%%%%%%%%%%%%%%%%%%%%%%%%%%%%%%%%%
    %-------------------Phase 2: Lat/Long Mask Creation----------------------
    --
    %{
        An LLA mask is created using the Corner Coordinates variable, found
        in the geoTIFF information property. Some geoTIFFs do not have grid
        resolutions defined within the information property so it is
        calculated
        by using the total number of points vs the range (assuming they are
        all
        equally spaced)
        Variables:
        lat_bounds: pulls latitude bounds from the ″info″ variable
        lon_bounds: pulls longitude bounds from the ″info″ variable
        lat_grid_res: calculates the latitude grid resolution based on the
        total number of latitude points and the bounds
        lon_grid_res: calculates the longitude grid resolution based on the
        total number of longitude points and the bounds
        [lon,lat]: reconstructs lat/long map based on the lat/lon bounds and
        the grid resolutions. Used later on as a reference to properly place
        the objects so there is no ″ghost points″
    %}
    disp(′Phase 2: Lat/Lon Mask Creation′);
    lat_bounds = info.CornerCoords.Lat;
    lon_bounds = info.CornerCoords.Lon;
    lat_grid_res = abs((max(lat_bounds)−
    min(lat_bounds))/size(orig_geoTIFF,1));
    lon_grid_res = abs((max(lon_bounds)−
    min(lon_bounds))/size(orig_geoTIFF,2));
    % reconstructs lat/long map based on metadata
    [lon,lat] = meshgrid(min(lon_bounds):lon_grid_res:max(lon_bounds)−
    lon_grid_res,...
        max(lat_bounds):−lat_grid_res:min(lat_bounds)+lat_grid_res);
    % Displays the original tiff image with lat/lon grid conversion
    figure;
    rx = surf(lon,lat,orig_geoTIFF(:,:,1)); % uses tiff intensity on Z and
    reconstructed lat/lon
    set(rx,′LineStyle′,′none′);
    colormap(gray);
    shading interp;
    xlabel(′Longitude [\circ]′);
    ylabel(′Latitude [\circ]′);
    zlabel(′Intensity [a.u.]′);
    title(″Original Image″);
    view(2); % top down view of geoTIFF
    %%
    %%%%%%%%%%%%%%%%%%%%%%%%%%%%%%%%%%%%%%%%%%%%%%%%%%%%%%%%%%%%%%%%%%%%%%%%
    %---------------------Phase 3: Object Importing--------------------------
    --
    %{
    The uigetfile command will create a User Interface allowing the User to
    select files that they would like to be processed. The text file needs to
    follow the format displayed below:
```

| | |
|---|---|
| Line 1: | BuildingName ′Name′ |
| Line 2: | NumPoints number |
| Line 3: | ConstructionType ′Top/Bottom′ |
| Line 4: | Height number |
| Line 5: | Latitude 1, Longitude 1 |
| Line 6: | Latitude 2, Longitude 2 |
| Line 7: | Latitude 3, Longitude 3 |
| Line 8: | ... , ... |
| Line N: | Latitude N,Longitude N |

```
    Note that you can have an infinite number of latitude or longitude points
    however, Lines 1 - 4 must be in the format shown above and below:
```

BuildingName Raft
NumPoints 6
ConstructionType Bottom
Height 50
39.0695,−86.408
39.0697,−86.408
39.0697,−86.407
39.0695,−86.407
39.0695,−86.408

```
    It is important to note that the readtable function will automatically
    ignore the first four lines within the text file. When the readtable
    function is executed it searches for a delimitated. In this instance the
    input file is formatted for the function to recognize the Delimiter {′,′}
    and ignore Whitespace ′b\t \. Since the first four lines of the file do
    not follow a format that MATLAB recognizes T (i.e. data Table) will
    import the first row that follows the delimiter constraint. Due to this
    importing process the T variable will look like the following:
        | Var1 | Var2 |
        ------------------------------
        | Latitude | Longitude |
    ------------------- IMPORTANT NOTES FILE IMPORTING ----------------------
    -
    If you are trying to upload multiple files into this code you will need
    to make sure that all your files are in one folder (i.e. directory). You
    will note be able to select multiple files that are in different
    locations.
        Variables
        filename_LLA: stores user input of the raw geoTIFF file
        points: pulls the lat/lon data into a table for manipulation
        idx: scans the data for any non-number inputs (NaN or strings)
        idy: performs a cumulative sum of the indexed ′idx′ values fro data
        sorting in ′C′
        idz: stores the size of the ′points′ table, including the non-number
        values
        C: returns a table without non-number values. Done by searching
        ′points′ for data that does not belong according to the conditions
    set
        by ′idy′ and ′idz′. See documentation for accumarray for more details
        lat_points: sorts the latitude points into its own matrix
        lon_points: sorts the longitude points into its own matrix
        terrain_bounds: creates the object boundaries using the ′lat,lon′
    grid
        created in Phase 1. Will be used for intersection calculations in
    Phase
        4
    %}
    disp(′Phase 3: Object Importing′);
    % Allows user input for number of files being read in
    answer = questdlg(′Are you inserting objects from seperate .txt files or
    are they all in one?′,...
          ′Options′,′Seperate′,′Single′,′Cancel′);
        switch answer
          case ′Single′ % best suited for terrain alteration
              disp(′Single File Option Selected. Please open a single .txt
    file with lat/long points′);
              T = DITTOImporterSingleFile( );
          case ′Seperate′
              disp(′Separate Files Option Selected. Please select all
    desired .txt files with lat/long points′);
              T = DITTOImporterMultipleFiles( );
          case ′Cancel′
              disp(′User Canceled operation, exiting program...′);
            return
        end
    % Separates lat/lon for all objects
    if gt(size(T,1),1) % if only one file is read in
        lat_points{:,1} = T.Latitude;
        lon_points{:,1} = T.Longitude;
        obj_height(:,1) = T.Properties.CustomProperties.Height;
        buildType{:,1} = T.Properties.CustomProperties.ConstructionType;
    else
        for i = 1:1:size(T,2) % if more than one file is read in
          lat_points{:,i} = T{i}.Latitude;
          lon_points{:,i} = T{i}.Longitude;
          obj_height(:,i) = T{i}.Properties.CustomProperties.Height;
          buildType{:,i} =
    T{i}.Properties.CustomProperties.ConstructionType;
        end
    end
    terrain_bounds = [min(lat(:,1)) min(lon(1,:));min(lat(:,1))
    max(lon(1,:));...
        max(lat(:,1)) max(lon(1,:));max(lat(:,1)) min(lon(1,:));min(lat(:,1))
    min(lon(1,:))];
    %%
    %%%%%%%%%%%%%%%%%%%%%%%%%%%%%%%%%%%%%%%%%%%%%%%%%%%%%%%%%%%%%%%%%%%%%%%%
    % --------------------Phase 4: TIFF Modification-------------------------
    --
    %{
        This is the main body of the script. It is all encompassed in
    recursive ′for′ loop that performs the object insertion for each object
    one at a time, allowing for multiple objects to be placed in one file.
    The procedure begins with reading in the desired height of the object
    from the .txt object file. Next, the nearest neighbors between the object
    and the reference grid are found and stored in a temporary variable
    called \object’
    This prevents the original object from being written to ″ghost″ points
    and forces the object to the resolution of the original image for
    simplicity.
    Then, the′ objects′ are converted into a 2D filled polygons. These
    polygons are used to find the intersection points between the object and
    the reference grid using the ′inpolygon′ function in Matlab, resulting in
    a dataset that contains all the points within the boundary conditions set
    by the object. This coverts the object from just boundary conditions to a
    solid shape that can be manipulated. The exact intersection lat/lon
    points are stored into ′lat_intersect′ and ′lon_intersect′, which will be
    used in the elevation alteration. An image of the resultant intersection
    in generated as a fact check.
    Next, the 2D object is converted to a 3D one through addition of Z-height
    to the data. This script has the ability to perform top-down and bottom-
    up insertion of objects. The top-down method is more suited for adding
    buildings and structures, as it will provide a fixed z-value. The bottom-
    up method is more suited for changing the elevation of the existing data,
    which would account for things like tree growth or pits. The user will
    define which operation they would like to perform within the object txt
    file. The user will also define one fixed z-value for the entire region
    or provide varying z-values in the .txt file. Finally, at the end of the
    recursive ′for′ loop, the altered geoTIFF image is displayed to the
    screen. It will include all the added objects and is the result that will
    be written to the output file
    %}
    disp(″Phase 4: geoTIFF Modification″);
    for j = 1:1:size (lat_points,2) % allows for multiple file inputs
        % Uses lat/lon look-up table to convert lat/lon to matlab position
        for i = 1:numel(lat_points{:,j})
          [~,idx_lat(i,j)] = min(abs(lat(:,1)−lat_points{1,j}(i,1)));
          [~,idx_lon(i,j)] = min(abs(lon(1,:)−lon_points{1,j}(i,1)));
        end
        object = [lat(idx_lat(:,j)) lon(1,idx_lon(:,j))′];
        %% Creates a 2D shape of the desired object
        poly1 = polyshape(object(:,2),object(:,1)); % creates polygon for
    object
        % Looks for the terrain points that are within the object boundaries
        in =inpolygon(lat,lon,object(:,1),object(:,2));
        % Stores intersection values, for use in elevation alteration
        lat_intersect = lat(in);
        lon_intersect = lon(in);
        % Displays the 2D object (sanity check)
        figure;
        plot(poly1);
        xlabel(′Longitude [\circ]′);
        ylabel(′Latitude [\circ]′);
        title(strcat(″Object 2D Shape: Object #″, num2str(j),″ from .txt″));
        grid on;
        grid minor;
        %% Raises all points within intersection by the height value
        switch string(buildType(:,j))
          case ′Bottom′ % best suited for terrain alteration
          disp(′Bottom-up method choosen, calculating elevation
    change...′);
          for i = 1:numel(lat(in))
              a = find(eq(lat(:,1),lat_intersect(i))); % looks up
    equivalent lat point
              b = find(eq(lon(1,:),lon_intersect(i))); % looks up
    equivalent lon point
              new_geoTIFF(a,b) = new_geoTIFF(a,b)+obj_height(:,j);
              z(a,b) = obj_height(:,j);
          end
          case ′Top′ % best suited for object insertion
          disp(′Top-down method choosen, inserting object...′);
          for i = 1:numel(lat(in))
              a = find(eq(lat(:,1),lat_intersect(i))); % looks up
    equivalent lat point
              b = find(eq(lon(1,:),lon_intersect(i))); % looks up
    equivalent lon point
              new_geoTIFF(a,b) = obj_height(:,j);
              z(a,b) = obj_height(:,j);
          end
          case ′Cancel′
          disp(′No valid choice made, please use Top or Bottom in txt file
    settings. Exiting program...′);
            return
        end
        % Sanity Check: Displays 3D render of object
        %{
        % Displays the created object
        % figure;
        % rz = surf(lon,lat,z);
        % set(rz,′LineStyle′,′none′);
        % colormap(jet);
        % shading interp;
        % xlabel(′Longitude [\circ]′);
        % ylabel(′Latitude [\circ]′);
        % zlabel(′Intensity [a.u.]′);
        % title(″Object 3D Shape″);
        %}
    end
    % Displays the altered tiff image
    figure;
    ry = surf(lon,lat,new_geoTIFF(:,:,1));
    set(ry,′LineStyle′,′none′);
    colormap(gray);
    shading interp;
    xlabel(′Longitude [\circ]′);
    ylabel(′Latitude [\circ]′);
    zlabel(′Intensity [a.u.]′);
    title(″Altered GeoTiff Image″);
    view(2)
    %%
    %%%%%%%%%%%%%%%%%%%%%%%%%%%%%%%%%%%%%%%%%%%%%%%%%%%%%%%%%%%%%%%%%%%%%%%%
    % -------------------Phase 5: Data Exporting-----------------------------
    --
    %{
        After the object insertion/elevation changes are finished, the new
        geoTIFF data is written. The output filenames are generated by
    removing
        the original file extension and appending ′_altered.tif′ to it. The
        same procedure is used for generating an object file name. To write a
        geoTIFF file, the raster path, lat/lon limits and the start point for
        the rastering need to be defined (done with ′R′).
    Note: If your image is inverted in any way, check the ′ColumnsStartFrom′
    setting first
        Variables:
        name: removes .tif from original file and stores for manipulation
        name_altered: creates filename for new geoTIFF file
        name_obj: creates a filename for the object files
        latlim: sets the latitude limits for the geoTIFF metadata
        lonlim: sets the longitude limits for the geoTIFF metadata
        rasterSize: sets the image size for the geoTIFF metadata
        R: stores the metadata settings for geoTIFF creation
    %}
    disp(′Objects Successfully Inserted! Writing geoTIFF now....′);
    % Renames files based on original
    name = strsplit(filename,′.tif′); % removes .tif from original file
    name_altered =
    strcat(convertCharsToStrings(char(name(1,1))),′_altered.tif′);
    name_obj =
    strcat(convertCharsToStrings(char(name(1,1))),′_object_only.tif′);
    % Creates the metadata needed to make a geoTIFF (i.e. the LL
    limits/range)
    latlim = [min(lat_bounds),max(lat_bounds)];
    lonlim = [min(lon_bounds),max(lon_bounds)];
rasterSize = [size(new_geoTIFF,1) ,size(new_geoTIFF,2)];
    R = georefcells(latlim,lonlim,rasterSize,′ColumnsStartFrom′,′north′);
    % Write the altered object file to a new .tiff
    geotiffwrite(strcat(outputPath,name_altered),new_geoTIFF,R);
    % Write an independent object tif file for sanity checks
    % tiffCreation(z,strcat(outputPath,name_obj));
```

One advantage of the present system and methods is that they allow a user to rapidly manipulate existing or easily accessible datasets to represent key factors needed for their simulation/visualization results. Prior to development of the present system, users would either need special access to the higher resolution datasets, which are not guaranteed to be up to date, or have to access 3D model files for buildings/obstacles (which are very hard to come by for non-commercial/public locations). The present system allows users to tailor their geoTIFF files to best suit their needs and allows the use of lower fidelity scan data. Another novel feature of this present system is the insertion/removal of objects in the metadata utilizing the metadata's own reference grid and resolution. This reduces the inaccuracies and artifacts seen when just “playing” and/or simply placing objects on top of the terrain data, as well as provides the ability to make seamless integrations of point cloud data or CAD files into low resolution terrain data.

While one focus of the present disclosure is to enhance the fidelity of geoTIFF datasets by inserting/removing objects in the metadata, the concepts disclosed herein could be translated to any system that utilizes georeferenced data, such as advanced AR/VR suites, 3D imagery generators, or even realistic battle simulators.

In further aspects, it is noted that the present system may be configured for managing and executing general processing, including the execution of software stored on computer-readable medium. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by a processor, causes the processing system (e.g., apparatus 201) to perform the various functions described above for any particular apparatus. The computer-readable medium and/or memory may also be used for storing data that is manipulated by a processor when executing software.

Furthermore, the computer-readable medium may be a non-transitory computer-readable medium (which may be incorporated in apparatus 201 as shown by at least one memory or memory device 220 in FIG. 2 as one example). A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may reside in the processor, external to the processor, or distributed across multiple entities including the system 200. The computer-readable medium may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system. In some further aspects, the computer-readable medium contains instructions that may cause the processor to implement the methods as described herein including the methods described below in connection with FIG. 10 or 11.

Although the invention has been described in detail with reference to certain preferred embodiments, variations and modifications exist within the spirit and scope of the invention as described and defined herein.

1. A method for model and simulation (M&S) of digital imagery and terrain data comprising:
receiving terrain and/or imagery files including geographic metadata;
extracting the geographic metadata of the received terrain and/or imagery files; and
modifying the extracted geographic metadata to represent changes in the terrain or to add assets to the received terrain and/or imagery files.

2. The method of claim 1, wherein modifying the extracted metadata includes rewriting the metadata of the received terrain and/or imagery files to create altered terrain and/or imagery files.

3. The method of claim 1, wherein the assets include buildings, geographic features, or trees.

4. The method of claim 1, wherein the terrain and/or imagery files are geoTIFF files.

5. The method of claim 1, further comprising:
receiving one or more object files; and
parsing the one or more object files to extract boundary or elevation characteristics in the one or more object files;
wherein modifying the extracted geographic metadata to represent changes in the terrain or to add assets to the received terrain and/or imagery files further includes modifying the extracted geographic metadata based on the extracted boundary or elevation characteristics.

6. The method of claim 1, wherein modifying the extracted geographic metadata to represent changes in the terrain or add assets to the received terrain and/or imagery files is selectable by a user.

7. A method for modifying terrain imagery files comprising:
receiving a terrain imagery file having embedded georeferencing metadata;
extracting the georeferencing metadata from the terrain imagery file;
assigning latitude and longitude ranges to the terrain imagery file based on the extracted georeferencing metadata;
selecting boundary latitude, longitude, and altitude (LLA) points within the assigned latitude and longitude ranges for alteration using at least one object file;
computing one or more intersections to determine points on a map that are within the selected boundary LLA points;
assigning at least one of new elevations or new features to the terrain imagery file based on the determined points on the map; and
generating a new terrain imagery file including the assigned at least one of new elevations or new features.

8. The method of claim 7, wherein the new features include buildings, geographic features, or trees.

9. The method of claim 7, wherein the terrain imagery file is a geoTIFF file.

10. The method of claim 7, further comprising:
receiving the one or more object files; and
parsing the one or more object files for assigning the latitude and longitude ranges to the terrain imagery file.

11. The method of claim 7, wherein generating a new terrain imagery file including the assigned at least one of new elevations or new features is selectable by a user.

12. The method of claim 7, wherein computing the one or more intersections includes determining intersection points between an object obtained from the at least one object file and a reference grid.

13. A non-transitory computer-readable medium storing computer executable code, wherein the code when executed by at least one processor causes the at least one processor to:
retrieve at least one GeoTIFF file;
extract geographic metadata contained within the at least one GeoTIFF file;
modify the extracted geographic metadata to represent changes in the terrain or adding assets to the at least one GeoTIFF file; and
rewrite the at least one GeoTIFF file with the modified extracted geographic data.

14. An apparatus for modifying terrain imagery files comprising:
at least one processor; and
at least one memory in communication with the at least one processor containing computer readable instructions;
wherein the at least one processor running the computer readable instructions is configured to:
retrieve at least one GeoTIFF file;
extract geographic metadata contained within the at least one GeoTIFF file;
modify the extracted geographic metadata to represent changes in the terrain or adding assets to the at least one GeoTIFF file; and
rewrite the at least one GeoTIFF file with the modified extracted geographic data.
